(19) United States
(12) Patent Application Publication
(10) Pub. No.: US 2007/0065711 A1
(43) Pub. Date: Mar. 22, 2007

(54) AIR INDEPENDENT POWER PRODUCTION

(76) Inventor: Ravi B. Gopal, Oakville, CA (US)

Correspondence Address: BERESKIN AND PARR, 40 KING STREET WEST, BOX 401, TORONTO, ON, M5H 3Y2, CA

(21) Appl. No.: 11/534,017

(22) Filed: Sep. 21, 2006

Related U.S. Application Data
(60) Provisional application No. 60/718,734, filed on Sep. 21, 2005.

(51) Int. Cl. H01M 8/24; H01M 8/04

(52) U.S. Cl. 429/38; 429/22; 429/13

(57) ABSTRACT

A fuel cell system having a fuel cell with a first reactant inlet, a first reactant outlet, a second reactant inlet, a second reactant outlet, a coolant inlet and coolant outlet. A first reactant supply subsystem supplies a first reactant incoming stream to the first reactant inlet of the fuel cell, and a second reactant supply subsystem supplies a second reactant incoming stream to the second reactant inlet of the fuel cell. A first reactant recirculation subsystem recirculates at least a portion of a first reactant exhaust stream from the first reactant outlet to the first reactant inlet. A second reactant recirculation subsystem can be provided for recirculating at least a portion of a second reactant exhaust stream from the second reactant outlet to the second reactant inlet. The first reactant is an oxidant gas and preferably an oxygen enriched gas. The oxygen enriched gas is preferably a mixture of oxygen and a gas which is inert to the fuel cell stack. The inert gas is preferably selected from the group consisting of nitrogen, carbon dioxide, helium, neon, argon, krypton, xenon, and radon. The oxygen concentration of the first reactant is advantageously between 20 to 50 percent by volume. The second reactant is preferably a fuel gas selected from the group consisting of purified hydrogen and reformate gas.

### FIELD OF THE INVENTION

The present invention relates to electrochemical cells, such as fuel cells, for producing electric power. More particularly, the present invention relates to a system having several cells combined into at least one cell stack and a method of operating the system in oxygen scarce environment.

### BACKGROUND OF THE INVENTION

Fuel cells have been proposed as a clean, efficient and environmentally friendly power source that has various applications. A conventional proton exchange membrane (PEM) fuel cell is typically comprised of an anode, a cathode, and a selective electrolytic membrane disposed between the two electrodes. A fuel cell generates electricity by bringing a fuel gas (typically hydrogen) and an oxidant gas (typically oxygen) respectively to the anode and the cathode. In reaction, a fuel such as hydrogen is oxidized at the anode to form cations (protons) and electrons by the reaction H₂=2H⁺+2e⁻. The proton exchange membrane facilitates the migration of protons from the anode to the cathode while preventing the electrons from passing through the membrane. As a result, the electrons are forced to flow through an external circuit thus providing an electrical current. At the cathode, oxygen reacts with electrons returned from the electrical circuit to form anions. The anions formed at the cathode react with the protons that have crossed the membrane to form liquid water as the reaction by-product following ½O₂+2H⁺+2e⁻=H₂O.

In practice, fuel cells are not operated as single units. Rather, fuel cells are connected in series, either stacked one on top of the other or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. The fuel cell stack, housing and associated hardware constitute a fuel cell module. Likewise, electrolyzer cells are also typically connected in series to form an electrolyzer stack.

In practice, the cells are not operated as single units. Rather, the cells are connected in series, stacked one on top of the other, or placed side by side. A series of cells, referred to as a cell stack or simply “a stack”, is normally enclosed in a housing. Also within the stack are current conductors, cell-to-cell seals and insulation. Piping and various instruments are externally connected to the stack for supplying and controlling the fluid streams in the system. The stack, housing, and associated hardware make up a fuel cell unit or system.

### SUMMARY OF THE INVENTION

In accordance with one aspect of the present invention, there is provided a fuel cell power module comprising:

a fuel cell stack and associated balance of plant to provide process fluids to and discharge process fluids from the fuel cell stack;

a first reactant inlet, a first reactant outlet, a second reactant inlet and a second reactant outlet for the fuel cell stack;

a first reactant supply subsystem, for supplying a first reactant incoming stream, and connected to the first reactant inlet, the first reactant comprising a mixture of at least a first component and a second component, the first reactant supply subsystem including a supply of the first component and a supply of the second component, and a controller for controlling supply of the first and second components to maintain a desired concentration of at least the first component in the first reactant; and

a first reactant recirculation subsystem, for recirculating at least a portion of a first reactant exhaust stream, connected between the first reactant outlet and the first reactant inlet.

At least the first component of the first reactant can be an oxidant gas and the first reactant can be an oxygen enriched gas. The oxygen enriched gas may be a mixture of oxygen and a gas which is inert to the fuel cell stack. The inert gas can be selected from the group consisting of nitrogen, carbon dioxide, helium, neon, argon, krypton, xenon, and radon.

The oxygen concentration of the first reactant is advantageously between 20 to 100 percent by volume, and more preferably between 20 to 50 percent by volume.

The second reactant can be a fuel gas selected from the group consisting of purified hydrogen and reformate gas.

The oxidant gas may be injected into the first reactant to compensate for impurity build-up as a result of the recirculation and also to compensate for the oxygen consumed.

The fuel cell stack system further has an electronic control unit (ECU), for process data acquisition and process control.

In the fuel cell stack system, each fuel cell stack can have a fuel cell voltage monitor (FCVM), which communicates detected cell voltages to the ECU.

The first reactant subsystem may have a nitrogen regulation valve in fluid communication with a nitrogen source and an oxygen regulation valve in fluid communication with an oxygen source, and wherein the ECU regulates the nitrogen regulation valve and the oxygen regulation valve to provide a nitrogen-oxygen mixture of a desired composition. The first reactant subsystem further has an oxygen gas pressure sensor, arranged to detect the oxygen gas pressure before mixing and to communicate the detected pressure as an electric signal to the ECU, an oxygen concentration detector, arranged to detect the oxygen gas concentration after mixing and to communicate the detected concentration as an electric signal to the ECU, and a nitrogen gas concentration sensor, arranged to detect the nitrogen gas concentration after mixing and to communicate the detected concentration as an electric signal to the ECU.

The second reactant subsystem may have a hydrogen regulation valve in fluid communication with a hydrogen source, the hydrogen regulation valve being regulated by the ECU, and a hydrogen gas pressure sensor arranged to detect the hydrogen pressure in the second reactant subsystem and communicate the detected pressure as an electric signal to the ECU.

In accordance with a second aspect of the present invention, there is provided a fuel cell power system comprising a plurality of fuel cell power modules,
wherein each fuel cell power module comprises a fuel cell stack and associated balance of plant for provision of process fluids to and discharge of process fluids from the fuel cell stack, a first reactant inlet, a first reactant outlet, a second reactant inlet and a second reactant outlet for the fuel cell stack;
a first reactant supply subsystem for supplying a first reactant incoming stream, and including a first reactant inlet manifold connected to the first reactant inlets of the fuel cell stacks and a first reactant outlet manifold connected to the first reactant outlets of the fuel cell stacks, a supply of a first component of the first reactant and a supply of a second component of the first reactant, both connected to the first reactant inlet manifold;
a controller connected to and controlling the supply of the first component of the first reactant and the supply of the second component of the first reactant, to maintain a desired concentration of at least the first component in the first reactant; and
a first reactant recirculation system, for recirculating at least a portion of the first reactant exhaust stream, connected between the first reactant inlets and the first reactant outlets.

In accordance with a third aspect of the present invention, there is provided a method of operating a fuel cell power module including a fuel cell, the method comprising:
providing separate supplies of a first component that is an oxidant and a second component that is inert in the fuel cell, and mixing the first and second components to form a first reactant gas;
supplying the first reactant gas to a first reactant inlet of the fuel cell as the oxidant gas;
supplying a fuel gas to a second reactant inlet of exhausting first reactant from a first reactant outlet of the fuel cell;
recirculating the first reactant gas from the first reactant outlet to the first reactant inlet; and
as the first component of the first reactant is consumed, supplying an additional amount of the first component to maintain a concentration of the first component in the first reactant gas at a desired level, and as required, supplying an additional amount of the second component to the first reactant gas to compensate for any losses.

### BRIEF DESCRIPTION OF THE DRAWINGS

For a better understanding of the present invention, and to show more clearly how it may be carried into effect, reference will now be made, by way of example, to the accompanying drawings, which show preferred embodiments of the present invention and in which:

FIG. 1 shows a fuel cell power module according to a first embodiment of the invention;

FIG. 2 shows a mechanical interface diagram for the fuel cell stack system according to the first embodiment of the invention;

FIG. 3 shows a communication interface diagram for the fuel cell stack system according to the first embodiment of the invention; and

FIG. 4 shows a fuel cell power system according to an embodiment of the invention.

### DETAILED DESCRIPTION OF THE INVENTION

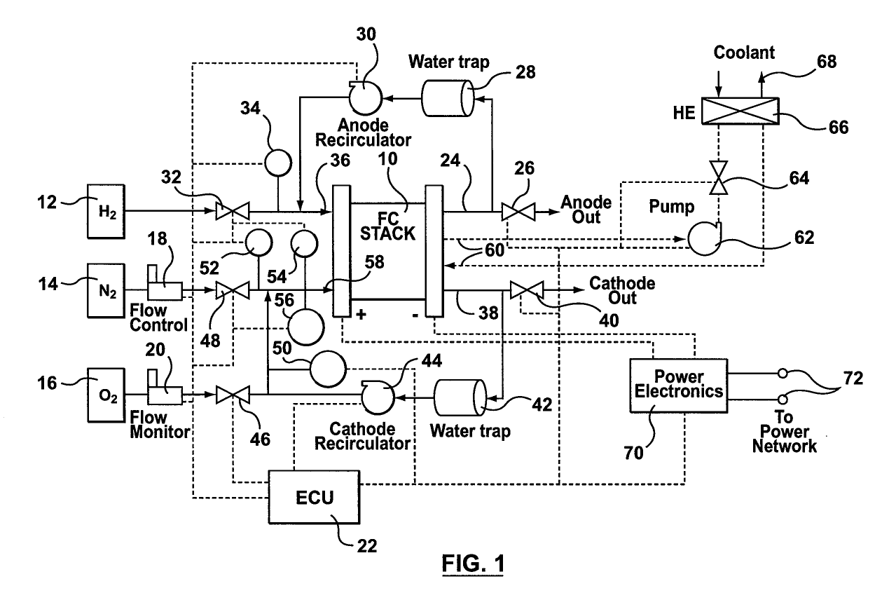

Referring to FIG. 1, a hydrogen fuel PEM (Proton Exchange Membrane) fuel cell stack system is utilized having an oxygen enriched cathode process gas (air) injection together with fuel and oxidant side gas re-circulation. The anode side of the fuel cells is fuelled with either substantially pure H₂, or a gas stream from a reformer; the cathode side is fed a mixture of a gas that is inert to the fuel cell and is generally referred to as the “oxidant”; as for some applications the oxidant composition simulates natural air with an oxygen concentration of close to 21%; in such cases the oxidant is also identified as “synthetic air”. For example the oxidant can have a composition of nitrogen, carbon dioxide, argon etc., and oxygen, with typically 35% O₂ concentration. The O₂ concentration may be varied, for example between 20 to 100 percent by volume or more preferably between 20 to 50 percent by volume. Higher oxygen concentration can increase fuel cell stack output, but at the expense, at least for current PEM technologies, of reducing the stack life. The further system description will be of a nitrogen inert gas system. In this context, in this specification, including the claims, the term “inert” means a gas that is non-reactive, or at least minimally reactive, with materials of the respective fuel cell, so as to have no or little effect on reactions in the fuel cell.

The stack is preferably operated in the dead-ended mode with recirculation on both the fuel and the oxidant sides with periodic purge of accumulated process water and built-up impurities. The recirculation rates are regulated by an ECU (electronic control unit) depending upon the actual FCPM (fuel cell power module) operating point. Thus, at a low operating point (i.e. low electrical power generation), the power consumption for recirculation is kept low. To effect recirculation, either a pump or a passive ejector nozzle (sonic nozzle) may be used. The nozzles work more efficiently when the gas flow rate is high, for low gas flow rates it is desirable to use active devices such as pumps. Thus, advantageously a combination of passive nozzle(s) and active pump(s) may be used, where the pumps are used predominantly during low electric output periods of the FCSS, e.g. start-up. By limiting the use of pumps in this way, the overall power consumption of the system is lowered and the life span of the pumps is enhanced.

A system for either constant or intermittent oxygen injection into the oxidant stream is utilised. Sensors are arranged in the system to detect the composition of the oxidant or “synthetic air” and regulate the oxygen injection rate so that the air composition falls within desired ranges.

Nitrogen (inert gas) and oxygen are stored with the FCPM, e.g. on-board the vessel or vehicle on which the fuel cell system is arranged. The storage may be in compressed, cryogenic (liquid), chemical storage form or any other suitable way of storage. Possible uses of the system according to the invention are on-board submarines, trucks, automobiles or space-going vessels. The system is especially useful where there is an absence of or limited supply of ambient air.

The system balance of plant includes the fuel and oxidant delivery components, the humidification systems, fuel and oxidant re-circulation, nitrogen replenishment system, the voltage monitoring system, power distribution centre and the electronic control unit. The fuel cell stack uses re-circulated nitrogen, with nitrogen replenishment to compensate for nitrogen losses due to, for example but not limited to, nitrogen crossing over the stack membrane to the anode side. The fuel cell stack system employs all the necessary control devices to regulate the quantity of heat rejected during operation. A liquid to liquid heat exchanger may be provided internally to isolate the internal cooling fluid from the external cooling water provided.

The fuel cell power module (FCPM) operates in the dead ended mode with recirculation on both the anode and cathode streams. However, there is a need to periodically purge the system to remove any contaminants as well as excess water at certain times. The purge is controlled automatically by the ECU and is dependent on various factors such as the temperature, cell voltages and the operating power levels. Advantageously, the excess hydrogen purged may be combusted in a catalytic style burner thereby releasing heat and water vapour. In addition, N₂ purge may be required on FCSS shut down, preferably on both the anode and cathode sides. The FCSS may be equipped with an Electronic Control Unit (ECU) for control and data acquisition. The ECU is responsible for start-up and shutdown, as well as for safety monitoring. Optionally, a second controller (not shown) dedicated to safety monitoring may be used in addition to the ECU. The ECU can communicate with an on-board Fuel Cell Voltage Monitor (FCVM) to monitor cell voltages within the stack. The various internal operating power requirements of the FCPM may be handled by a Multipoint Power Converter (MPC) or optionally are user supplied (i.e. performed by systems outside of the FCPM. An optional data logger can be supplied. The FCPM may incorporate safety check routines for safe reliable operation. All safety checks may be handled by the ECU. The FCPM may communicate with the external devices using a CANBUS interface. The FCPM may interface to an external network with the use of power electronics to manage the power flow. The FCPM may be advantageously current and power limited to prevent overloads. The FCPM may further incorporate a pilot battery for start-up power. Once the FCPM is up and running, the system may be power neutral i.e. the balance of plant power is provided by the FC stack itself.

The FCPM produces water, predominantly on the cathode side. Since the oxidant side is a closed loop re-circulating process, the water may be collected in a water collection vessel with a periodic drain feature.

Referring to FIG. 1, a FCPM is shown including a fuel cell stack 10, and having hydrogen, nitrogen and oxygen gas flows provided from respectively, a hydrogen storage tank 12, a nitrogen storage tank 14 and an oxygen storage tank 16. The nitrogen flow is regulated and/or monitored by a flow control device 18 and the oxygen flow is regulated and/or monitored using a flow control device 20. An electronic control unit 22 (ECU) receives and transmits control signals from devices in the system under the ECU's control; the flow control device 18, the flow control device 20 the various regulation valves and the various sensors (pressure, temperature, concentration etc.). The FCPM general layout may be a conventional PEM FC layout as described, for instance, in the applicant's published U.S. 2003/0194590 application, hereby incorporated by reference.

Fuel cell stack 10 has an anode outlet 24 connected to an anode outlet or purge valve 26, that is connected to and controlled by ECU 22. The anode outlet 24 is also connected through a water trap 28 to an anode recirculator 30. As noted above, the recirculator 30 can comprise one or more pumps and/or one or more nozzles, again connected to and controlled by the ECU 22.

The hydrogen supply tank 12 is connected through a control valve 32 to an anode inlet 36 of the fuel cell stack 10. A pressure sensor 34 is provided for measuring the anode inlet pressure, with both the valve 32 and pressure sensor 34 being connected to the ECU 22. The outlet of the anode recirculator 30 is also connected to the anode inlet 36.

On the cathode side, a cathode outlet 38 of the fuel cell stack 10 is connected to a cathode outlet or purge valve 40 and also to a cathode water trap 42. The water trap 42 in turn is connected to a cathode recirculator 44, that, like the recirculator 30, may comprise one or more pumps and/or one or more recirculation nozzles.

The oxygen tank 16 is connected through the flow control device 20 to an oxygen control valve 46, and both the outlet of the valve 46 and the cathode recirculator 44 are connected to a cathode inlet 58 of the fuel cell stack 10. The nitrogen stack 14 is connected through the flow control device 18 also to the cathode inlet 58.

Required sensors are provided for monitoring both the pressure and constitution of the cathode inlet gas. Thus, at least one pressure sensor 50 is provided for the recirculated cathode flow, and if required, an additional pressure sensor 52 can be provided for monitoring the nitrogen pressure flow. A nitrogen sensor 54 and an oxygen sensor 56 are also provided for monitoring the nitrogen and oxygen levels in the incoming cathode gas flow. The oxygen sensor can be sensitive to temperature and relative humidity, and for this reason, can be housed in temperature controlled housing or otherwise maintained within desired temperature limits.

For many fuel cells, particularly fuel cells with proton exchange membranes (PEM), it is desirable to avoid significant pressure differentials within the cell stack. For this purpose, the hydrogen or fuel pressure may be set to track the pressure of the oxidant stream, while being maintained slightly higher so that any leakage is preferentially from the fuel side to the oxidant side.

The various sensors 50-56 and valves 46 and 48 are also connected to and controlled by ECU 22.

The ECU 22 is additionally connected to the anode and cathode outlet or purge valves 26, 40 for control thereof.

The fuel cell stack 10 has a power output connected to power electronics 70, provided with output connections 72 for transferring power to a power network.

In known manner, to keep the fuel cell stack 10 at a required operating temperature and to dissipate waste heat, the stack 10 has coolant connections 60, that are connected through a coolant pump 62 and control valve 64 to a heat exchanger 66. As indicated schematically at 68, a secondary coolant flows through the other side of the heat exchanger for removing heat. The coolant valve 64 and the coolant pump 62 are also connected to and controlled by the electronic control unit (ECU) 22.

The power electronics 70 are connected to and controlled by the ECU 22.

In use, nitrogen and oxygen are mixed using the nitrogen regulation valve 48 and an oxygen regulation valve 46, as controlled by the ECU 22, to produce a synthetic air mixture according to a pre-set composition. The pressure of the oxygen gas and circulated gas is monitored by the ECU 22 via the oxygen pressure transmitter 50 arranged downstream of the oxygen regulation valve. Similarly, the oxygen concentration and the nitrogen concentration are monitored, preferably in real time, by the ECU 22 via the oxygen concentration sensor 56 and the nitrogen concentration sensor 54, respectively, arranged downstream of the mixing point of nitrogen and oxygen gas streams. Hydrogen (fuel) gas pressure is similarly monitored by the ECU 22 via the hydrogen pressure transmitter 34 arranged downstream of a hydrogen regulation valve 32.

Oxygen injection may be regulated using a forward-pressure regulator (not shown) or using metered injection. The latter alternative is more expensive, but may be advantageous when detailed control is desired over the oxygen injection. Similarly, hydrogen injection may be regulated using a forward-pressure regulator (not shown), using metered injection or using an on-line reformer and operating the fuel cell system in fuel-following mode. In fuel-following mode the anode pressure is monitored and when pressure drops, the electrical load on the fuel cells is lowered to avoid fuel starvation. If the pressure is high, the reformer produces more hydrogen and the electrical load may be increased. Any extra electricity generated may be stored using batteries. It is essential to avoid over- or under-consumption of hydrogen (reformate gas) in order to permit the reformer to run optimally.

Hydrogen is recirculated to the anode inlet 36 of the fuel cell stack 10 by the anode recirculator 30 via the anode water trap 28. Similarly, the oxidant or synthetic air is recirculated to the cathode inlet 58 of the fuel cell stack 10 by the cathode recirculator 44 via a cathode water trap 42, to avoid excessive loss of nitrogen to the atmosphere. Purging of the anode gas stream is performed using the anode purge valve 26, when necessary. Similarly, purging of the cathode gas stream is performed using a cathode purge valve 40, when necessary.

In the recirculation loops on the anode and cathode sides, humidification devices may be employed to control the humidity of the process gases. Water recovered in the water traps 28, 42 may be recovered for reuse, and the water traps 28, 42 may, to at least some extent, be integral with the stack 10.

Anode and cathode process gases may be recirculated using any suitable pump technology. Examples are diaphragm pumps, liquid ring pumps, centrifugal pumps etc. The level of recirculation of one or both of the oxidant as a first reactant and the fuel gas as a second reactant, by the recirculators 44 and 30, respectively, can be varied depending on load, with recirculation being reduced at low load levels to reduce parisitic losses.

Fuel cell stack coolant may be circulated through the stack via the coolant pump 62 and controlled by the coolant regulation valve 64 (for regulating the coolant flow rate by the ECU). The coolant is advantageously run through the coolant heat exchanger 66, so that an external cooling fluid, for example water, may remove excess heat from the stack coolant before the stack coolant is recirculated to the stack.

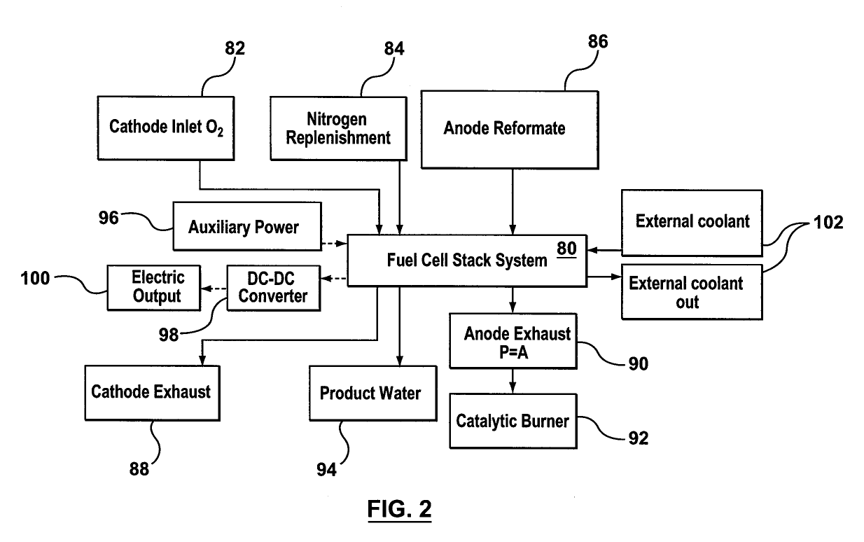

FIG. 2 illustrates one example of operating parameters and input/output gasses and power requirements for an FCSS according to the present invention. Reformate gas is used as fuel and nitrogen and oxygen are used to provide synthetic air oxidant gas. A catalytic burner may be arranged on the anode exhaust to remove hydrogen from the off-gas. Alternatively and not shown, the anode off-gas may be recirculated to the reformer (when a reformer is part of the system) and burned in the reformer to generate heat for the reformation process.

Thus, in FIG. 2, the fuel cell stack system is intended to be a relatively small system, and some exemplary values of various parameters are set out below, but it is to be understood that these would be varied depending upon the nature and size of each installation.

As shown, at the cathode inlet, oxygen may be provided at 34 slpm from a supply at a pressure of 8 bars (absolute). Similarly, nitrogen replenishment may be provided at similar temperature and pressure conditions, with the flow rate to be determined as required. The fuel here is reformate fuel, the actual fuel being hydrogen mixed with other gases generated by the reformation process. This may be provided at a flow rate of 68 slpm.

As indicated at 88, the cathode exhaust may be at atmospheric pressure and a temperature of less than 45 degrees C., and the anode exhaust at 90 may also be at atmospheric pressure. As indicated at 92, a catalytic burner, may, optionally, be provided. Product water is collected at 94, and atmospheric pressure with the rate of collection being anticipated to be less than 50 cc per minute.

Where required, an auxiliary power supply 96 may be provided, providing 1 kw of power at 220 volts, single phase for running balance of plant equipment, connected to the fuel cell stack system 80. The power output of the fuel cell stack system 80 may be connected to a DC converter 98, and may then provide an electrical output at 360 volts DC as indicated at 100.

An inlet and an outlet for an external coolant are indicated at 102, and it is anticipated that the coolant may be provided at the rate of 50 litres per minute with a temperature in the range of 15-20 degrees C.

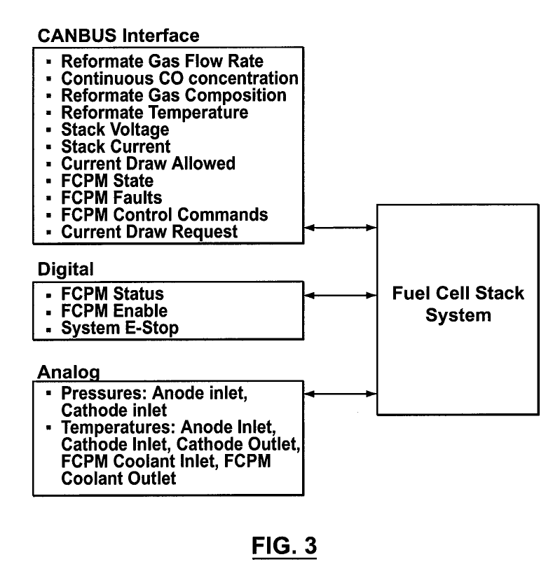

FIG. 3 shows an embodiment of interface signals to/from the FCSS according to the invention. Naturally, the number and type of interface signals may be varied to suit specific circumstances. Other serial interfaces than the CANBUS may be used and all signals may be transmitted in digital form, if desired (i.e. no analog signals would be transmitted from the FCSS to the outside).

FIG. 3 anticipates that, as for FIG. 2, reformate gas would be used as the fuel supply. Thus, parameters relevant to reformate gas may be monitored such as CO concentration, condensation, temperature, etc. Reference to “FCPM” indicates the fuel cell power module, the fuel cell stack 10 and its associated balance of plant components.

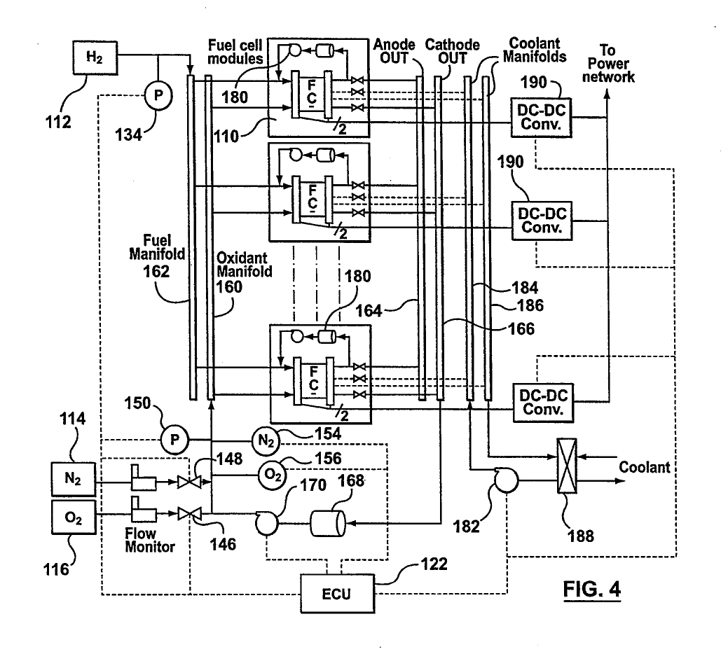

An embodiment of a fuel cell power system (FCPS) is shown in FIG. 4. A number of individual fuel cell power modules 110 (FCPM) are utilized to attain higher power requirement (compared to a single FCPM), for example FCPM as described in FIG. 1. From both a process (i.e. fluid flow) as well as an electrical point of view, it is preferred that the modules be operated in parallel. Such an arrangement provides an inherent redundant architecture and allows any individual module to be isolated in case of any fault, while the others continue to provide power. Further, the individual fuel cell stacks may be of a modular architecture to facilitate replacement of one stack and to simplify manufacture resulting in cost reductions. Each module 110 has dedicated re-circulation, purge and coolant flow control with the process gases and fluids flowing in and out of manifolds. Each module forms a self-contained unit, which is operable directly after being connected to external process gas supplies and start-up electrical power. The modules advantageously provide process parameter measurement electrical signals to the outside world via their ECU's. Alternatively, one recirculation pump may serve two or more modules depending on capacity for each of anode and cathode gas flows. The power output of each stack is individually managed power converters such as by DC-DC or DC-AC converters to provide redundant-style architecture. The converters may either ‘buck’ or ‘boost’ the voltage output of the fuel cell modules to a level needed by the application. The power management devices also facilitate equal or desired load distribution amongst the various fuel cell modules. A master system is employed for supervisory and feedback control as well as data acquisition.

The oxidant or synthetic air production may be common to all FCPMs 110 and may be performed as described above for one FCPM. Nitrogen and oxygen, from respective tanks 114, 116 are mixed using a nitrogen regulation valve 148 and an oxygen regulation valve 146, which are controlled by the ECU 122 to produce an oxidant or synthetic air mixture according to a pre-set composition. The gas pressure is monitored by the ECU 122 via a pressure transmitter 150 arranged downstream of the oxygen regulation valve. Similarly, the oxygen concentration and the nitrogen concentration are monitored, preferably in real time, by the ECU via an oxygen concentration sensor 156 and a nitrogen concentration sensor 154, respectively, arranged downstream of the mixing point of nitrogen and oxygen gas streams. The oxidant may then be distributed to the FCPMs using an oxidant manifold 160, i.e. the oxidant manifold 160 is common to all FCPMs. Hydrogen (fuel) gas pressure is similarly monitored by the ECU via a hydrogen pressure transmitter 134 arranged downstream of a hydrogen regulation valve (not shown), connected to a hydrogen tank or source 112. Hydrogen may then be distributed to the FCPMs using a fuel manifold 162, i.e. the fuel manifold 162 is common to all FCPMs. Similarly, the anode exhaust of each FCPM is collected in a common anode OUT manifold 164 and anode exhaust is recirculated (not shown) to the fuel manifold. Also, the cathode exhaust of each FCPM is collected in a common cathode OUT manifold 166 and cathode exhaust is recirculated to the oxidant manifold through a water trap 168 and recirculation 170. Alternatively, each FCPM has its own recirculator of process gasses, although this is not shown.

In use, the fuel cell stack system, as detailed below, can initially be filled with just the inert or non-reactive component of the first reactant, e.g. the nitrogen, so as to inhibit or stop any electrochemical reactions. On startup, it is operated by first supplying the stack 10 with an oxidant, as the first reactant, to the inlet 58, that has desired concentrations of both oxygen and nitrogen. As mentioned, typically it is expected that the oxidant will simulate natural air, and thus will comprise approximately 21% oxygen with the balance being nitrogen.

However, these concentration levels can be varied. Practically, it has been found that it is desirable to maintain a minimum 21% concentration of oxygen, as below this level, many fuel cells become unstable. For some types of operations, it may be desirable to increase the oxygen concentration and/or operate at a higher pressure, so as to obtain a higher power outlet. Thus, the pressure of the gases in the stack can be increased by, for example, 2 to 3 psi. Additionally, the oxygen concentration can be run at, for example, 35%. The oxidant concentration can be increased for a short period of time, to give a short, transient burst of power. For example, the oxygen concentration could be increased to 50% for a short time. It is generally undesirable for PEM type fuel cells, to maintain the oxygen level high for any lengthy period, since this can lead to shortened life of the cell stack; the higher power level tends to shorten the life of the membranes.

On initial startup, the fuel cell stack 10 can have just nitrogen present. Oxygen is then added until the desired concentration is reached, with excess nitrogen or other inert gas being purged if necessary, to enable power generation to start. Then, it should only be necessary to add oxygen, to compensate for oxygen consumed in the cell stack 10. There may be some diffusion of nitrogen through membranes of the cells to the anode side, which ultimately will be discharged during purge cycles. Additionally, purge cycles on the cathode side will lead to some loss of nitrogen, and both these losses will need to be compensated by supply of additional oxygen.

A further reason to avoid use of pure oxygen, or even high oxygen concentration levels is that in a cell stack 10, the hydrogen and oxygen are separated just by the membranes. If there was any leakage, due to the catalyst present, one can have violent reactions occurring, which tends to limit the life of the cell stack. Thus, it is desirable to run at lower oxygen concentrations at the present general state of the technology.

In applications where storage space is limited, for example in the underwater or submarine applications, it may be desirable to store oxygen cryogenically, to minimize its stored volume. In known manner, the oxygen is then taken from the cryogenic supply, heated and revaporized and supplied as required. The relatively smaller amount of makeup nitrogen could be stored in compressed form.

With respect to the second embodiment of the invention shown in FIG. 4, including a number of individual fuel cell power modules 110, a number of variants are possible within this overall scheme. Thus, as indicated at 180, it is possible for individual fuel cell power modules 110 to be provided with recirculation of the fuel gas at least, and this can be in addition to or instead of common recirculation between the fuel manifolds 162, 164. It is also possible that, within each fuel cell module 110, individual recirculation of the oxidant or cathode gas could be provided, although this would be more complicated, since it would require a separate provision of makeup oxygen and nitrogen to each fuel cell power module 110; again internal or individual cathode recirculation be provided instead of, or possibly as well as, common recirculation using the manifolds 160, 166. A common coolant arrangement is provided for the fuel cell power modules 110, although again individual cooling could be provided. Thus, a coolant pump 182 is connected to manifolds 184 and 186, with each fuel cell power module to the power manifolds 184, 186. Fluid returned back from the manifold 186 passes through a heat exchanger 188 and then flows to the inlet of the recirculation pump 182 for the coolant. As for the first embodiment, the heat exchanger 188 exchanges heat with a secondary fluid stream.

The power output of each fuel cell power module 110 is connected to a respective DC-DC converter, indicated at 190, and the outputs of the various DC-DC converters are connected to a power network. As indicated by dashed lines, the electronic control unit 122 is connected to the coolant pump 182 and the DC-DC converters 190.

In use, upon termination of operation of the fuel cell stack 10, the oxygen supply can be turned off and oxygen consumed and/or purged, until there is just nitrogen present in the fuel cell stack 10. This ensures that there is just inert, nitrogen gas on the cathode side of each cell, so as effectively to prevent further power generation, and the stack 10 can then be switched to a dormant state.

It is important to share the electrical load equally among the FCPMs using power electronics, in order to not over-stress one FCPM relative to the other FCPMs. By sharing equally, the longevity of the FCPMs is enhanced as well as being substantially equal for all FCPMs. Using modular FCPMs, any replacement may be performed relatively easily using vehicle/vessel on-board reserves, if desired.

While the above description constitutes the preferred embodiments, it will be appreciated that the present invention is susceptible to modification and change without departing from the fair meaning of the proper scope of the accompanying claims. While reference is made, variously, to a fuel cell or fuel cell stack, it will be understood that the invention is generally applicable to any type of fuel cell, that might comprise a single fuel cell, or more commonly a stack of fuel cells.

1. A fuel cell power module comprising:
a fuel cell stack and associated balance of plant to provide process fluids to and discharge process fluids from the fuel cell stack;
a first reactant inlet, a first reactant outlet, a second reactant inlet and a second reactant outlet for the fuel cell stack;
a first reactant supply subsystem, for supplying a first reactant incoming stream, and connected to the first reactant inlet, the first reactant comprising a mixture of at least a first component and a second component, the first reactant supply subsystem including a supply of the first component and a supply of the second component, and a controller for controlling supply of the first and second components to maintain a desired concentration of at least the first component in the first reactant; and
a first reactant recirculation subsystem, for recirculating at least a portion of a first reactant exhaust stream, connected between the first reactant outlet and the first reactant inlet.

2. The fuel cell power module as recited in claim 1, wherein at least the first component of the first reactant is an oxidant gas.

3. The fuel cell power module as recited in claim 3, wherein the first reactant comprises an oxygen enriched gas, with the second component of the first gas comprising a gas that is inert to the fuel cell stack.

4. The fuel cell power module as recited in claim 4, wherein the second component of the first reactant comprises at least one gas selected from the group consisting of nitrogen, carbon dioxide, helium, neon, argon, krypton, xenon, and radon.

5. The fuel cell power module as recited in claim 1, wherein the controller is set to maintain an oxygen concentration of the first reactant between 20 to 100 percent by volume.

6. The fuel cell power module as recited in claim 5, wherein the controller is set to maintain an oxygen concentration of the first reactant between 20 to 50 percent by volume.

7. The fuel cell power module as recited in any of claims 1 to 6, wherein the second reactant is a fuel gas selected from the group consisting of purified hydrogen and reformate gas.

8. The fuel cell power module as recited in claim 3, wherein the controller comprises an electronic control unit, for process data acquisition and process control.

9. A fuel cell power module as claimed in claim 8, including a second reactant recirculation subsystem connected between the second reactant outlet and the second reactant inlet.

10. The fuel cell power module as recited in claim 9, wherein the fuel cell stack has a fuel cell voltage monitor, which communicates detected cell voltages to the electronic control unit.

11. The fuel cell power module as recited in claim 10, wherein the first component comprises oxygen and the second component comprises nitrogen, and wherein the first reactant subsystem includes a nitrogen regulation valve in fluid communication with a nitrogen source and an oxygen regulation valve in fluid communication with an oxygen source, and wherein the electronic control unit regulates the nitrogen regulation valve and the oxygen regulation valve to provide a nitrogen-oxygen mixture of a desired composition.

12. The fuel cell power module as recited in claim 12, wherein the first reactant subsystem comprises an oxygen gas pressure sensor, arranged to detect the oxygen gas pressure before mixing and to communicate the detected pressure to the electronic control unit, an oxygen concentration detector, arranged to detect the oxygen gas concentration after mixing and to communicate the detected concentration as to the electronic control unit, and a nitrogen gas concentration sensor, arranged to detect the nitrogen gas concentration after mixing and to communicate the detected concentration electronic control unit.

13. The fuel cell power module as recited in claim 12, wherein the second reactant subsystem comprises a hydrogen regulation valve in fluid communication with a hydrogen source, the hydrogen regulation valve being regulated by the electronic control unit, and a hydrogen gas pressure sensor arranged to detect the hydrogen pressure in the second reactant subsystem and communicate the detected pressure the electronic control unit.

14. A fuel cell power system comprising a plurality of fuel cell power modules,
wherein each fuel cell power module comprises a fuel cell stack and associated balance of plant for provision of process fluids to and discharge of process fluids from the fuel cell stack, a first reactant inlet, a first reactant outlet, a second reactant inlet and a second reactant outlet for the fuel cell stack;
a first reactant supply subsystem for supplying a first reactant incoming stream, and including a first reactant inlet manifold connected to the first reactant inlets of the fuel cell stacks and a first reactant outlet manifold connected to the first reactant outlets of the fuel cell stacks, a supply of a first component of the first reactant and a supply of a second component of the first reactant, both connected to the first reactant inlet manifold;
a controller connected to and controlling the supply of the first component of the first reactant and the supply of the second component of the first reactant, to maintain a desired concentration of at least the first component in the first reactant; and
a first reactant recirculation system, for recirculating at least a portion of the first reactant exhaust stream, connected between the first reactant inlets and the first reactant outlets.

15. A fuel cell power system as claimed in claim 14, wherein the first reactant recirculation system comprises a common recirculation system connected between the first reactant inlet manifold and the first reactant outlet manifold.

16. A fuel cell power system as claimed in claim 14, wherein the first reactant recirculation system comprises, for each fuel cell power module, an individual recirculation system connected between the first reactant inlet and the first reactant outlet of the corresponding fuel cell power module.

17. A fuel cell power system as claimed in claim 14, including a second reactant circulation system connected to the second reactant inlets and the second reactant outlets.

18. A fuel cell power system as claimed in claim 17, wherein the second reactant circulation system comprises at least one of a second reactant circulation subsystem for each fuel cell stack connected between the second reactant inlet thereof and the respective second reactant outlet thereof, and a common second reactant recirculation subsystem with a second reactant inlet manifold and a second reactant outlet manifold connected between the second reactant inlets and second reactant outlets of the fuel cell stacks.

19. A fuel cell power system as claimed in claim 18, including a common coolant supply connected through a respective coolant manifold to the fuel cell stacks.

20. A method of operating a fuel cell power module including a fuel cell, the method comprising:
providing separate supplies of a first component that is an oxidant and a second component that is inert in the fuel cell, and mixing the first and second components to form a first reactant gas;
supplying the first reactant gas to a first reactant inlet of the fuel cell as the oxidant gas;
supplying a fuel gas to a second reactant inlet of the fuel cell;
exhausting first reactant from a first reactant outlet of the fuel cell;
recirculating the first reactant gas from the first reactant outlet to the first reactant inlet; and
as the first component of the first reactant is consumed, supplying an additional amount of the first component to maintain a concentration of the first component in the first reactant gas at a desired level, and as required, supplying an additional amount of the second component to the first reactant gas to compensate for any losses.

21. A method as claimed in claim 20, the method including:
when the fuel cell is idle, providing the cathode side of the fuel cell with just the second component of the first reactant, to inhibit electrochemical reaction; and
on startup, circulating the first reactant through the cathode of the fuel cell and adding the first component to the first reactant flow, until a desired concentration of the first component is reached.

22. A method as claimed in claim 20, the method including, for generating a transient power increase, at least one of:
increasing the pressure of the first and second reactant supplied to the fuel cell; and
increasing the concentration of the first component in the first reactant.
